(19) United States
(12) Patent Application Publication
(10) Pub. No.: US 2002/0196407 A1
(43) Pub. Date: Dec. 26, 2002

(54) Combination spectacle frame

(76) Inventor: Ting Kin Liu, Hong Kong (HK)

Correspondence Address: NATH & ASSOCIATES, 1030 15th STREET, 6TH FLOOR, WASHINGTON, DC, 20005, US

(21) Appl. No.: 09/884,053

(22) Filed: Jun. 20, 2001

(51) Int. Cl. G02C 9/00

(52) U.S. Cl. 351/47

(57) ABSTRACT

The invention comprises a spectacle frame and an auxiliary frame. The spectacle frame includes spectacle eyeglass holding means, a pair of arms, and first attachment means. The auxiliary frame includes auxiliary eyeglass holding means, and second attachment means. One of the first attachment means and second attachment means is formed of magnetic material and the other attachment means is formed of magnetically attractable material so that, in use, the auxiliary frame may be mounted on the spectacle frame by magnetic attraction between the first attachment means and second attachment means and with the auxiliary eyeglass holding means substantially overlying the spectacle eyeglass holding means.

### BACKGROUND OF THE INVENTION

This invention relates to spectacle clip-on arrangements. Such arrangements have a primary spectacle frame which is worn, in use, substantially in the normal manner but with an attachable auxiliary spectacle frame which may have speciality lenses associated therewith, for example, sunglasses. As is well known the primary spectacle frames can be used in the normal manner but, in the case of sunglasses, where there is substantial sunlight or when a person moves from an inside location with respect to a building to outside the building, the auxiliary spectacle frame is attached to the primary spectacle frame so as to reduce, for example, brightness or glare.

With combination primary spectacle frames and detachable auxiliary spectacle frames as outlined above, it has become common to construct such spectacle combinations so that the auxiliary spectacle frame is detachably held on the primary spectacle frame by providing magnets on both the primary spectacle frame and the auxiliary spectacle frame. Such magnets are aligned so that with the auxiliary spectacle frame correctly positioned, opposite magnetic poles are provided adjacent one another so that the auxiliary spectacle frame is attracted to and held in the correct position relative to the primary spectacle frame.

However a number of medical research reports have disclosed that magnetic fields may harm human brain nerves. There is a risk therefore that magnetic waves caused by spectacle frame assemblies having a primary spectacle frame and detachable auxiliary spectacle frame each using magnets to provide the clip-on mechanism is harmful to human health.

### OBJECT OF THE INVENTION

It is an object of the present invention to provide a combination spectacle frame which will obviate or minimise the foregoing disadvantages in a simple yet effective manner or which will at least provide the public with a usefull choice.

### STATEMENTS OF THE INVENTION

Accordingly the invention may broadly be said to consist in a combination comprising a spectacle frame and an auxiliary frame, the spectacle frame including spectacle eyeglass holding means, a pair of arms, and first attachment means, the auxiliary frame including auxiliary eyeglass holding means, and second attachment means, one of the first attachment means and second attachment means being formed of magnetic material and the other attachment means being formed of magnetically attractable material so that, in use, the auxiliary frame may be mounted on the spectacle frame by magnetic attraction between the first attachment means and second attachment means and with the auxiliary eyeglass holding means substantially overlying the spectacle eyeglass holding means.

Preferably the first attachment means and second attachment means are provided in a pair of positions, there being one position substantially at each side of the spectacle frame and auxiliary frame respectively.

Preferably the first attachment means comprises a pair of first planar members positioned one each side of the spectacle eyeglass holding means and the second attachment means comprises a pair of second planar members positioned one each side of the auxiliary eyeglass holding members.

Preferably the first and second planar members are substantially vertical when the spectacle frames are normally positioned on the head of a user.

Alternatively the first and second planar members are substantially horizontal when the spectacle frames are normally positioned on the head of a user.

Preferably the second planar members are outside the first planar members.

Preferably the second planar members are inside the first planar members.

Preferably the first planar members form part of the structure of the arms of the spectacle frame.

Preferably the first attachment means are formed of magnetically attractable material and the second attachment means are formed of magnetic material.

### BRIEF DESCRIPTION OF DRAWINGS

One preferred form of the invention will now be described with reference to the accompanying drawings in which,

FIG. 1 is a perspective view of a combination of spectacle frame and auxiliary clip-on spectacle frame according to one preferred form of the invention,

FIG. 2 is a perspective view of the combination of FIG. 1 in engagement,

FIG. 3 is a view as in FIG. 1 of an alternative embodiment of the invention,

FIG. 4 is a view as in FIG. 2 of the embodiment of the invention shown in FIG. 3,

FIG. 5 is a view as in FIG. 1 of a still further alternative embodiment of the invention,

FIG. 6 is a view as in FIG. 2 of the embodiment of the invention shown in FIG. 5,

FIG. 7 is a view as in FIG. 1 of a still further alternative embodiment of the invention,

FIG. 8 is a view as in FIG. 2 of the embodiment of the invention shown in FIG. 7.

### DESCRIPTION OF THE PREFERRED EMBODIMENT

Referring to the drawings a combination of spectacle frame 1 and auxiliary clip-on frame 2 is provided. The frame 1 comprises spectacle eyeglass holding means 3 which may be in any form able to hold eyeglasses 4. The spectacle frames include other known portions such as a bridge 5 and nose supports 6 which again may be in any form. The spectacle frame 1 also includes arms 13.

The auxiliary frame 2 includes auxiliary eyeglass holding portions 10 for the auxiliary lenses 11 and auxiliary bridge 12.

Spectacle frame 1 further includes first attachment means and the auxiliary frame 2 includes second attachment means. One of the attachment means is formed of a magnetic material and the other attachment means is formed of magnetically attractable material. In the preferred form the auxiliary frame 2 carries attachment means having the magnetic material and the spectacle frame 1 carries the attachment means having or comprising the magnetically attractable material. The magnetic means and magnetically attractable material may be formed in any number of ways and, for example, the magnetic means may comprise magnets formed, for example of ferro magnetic materials or having ferro magnetic material embedded, for example in plastics material. Magnetic strips can be attached or embedded in the frames. Similarly the magnetically attractable material could be formed of any material which is able to be magnetically attracted by a magnet or having such material contained, for example, within a plastics material.

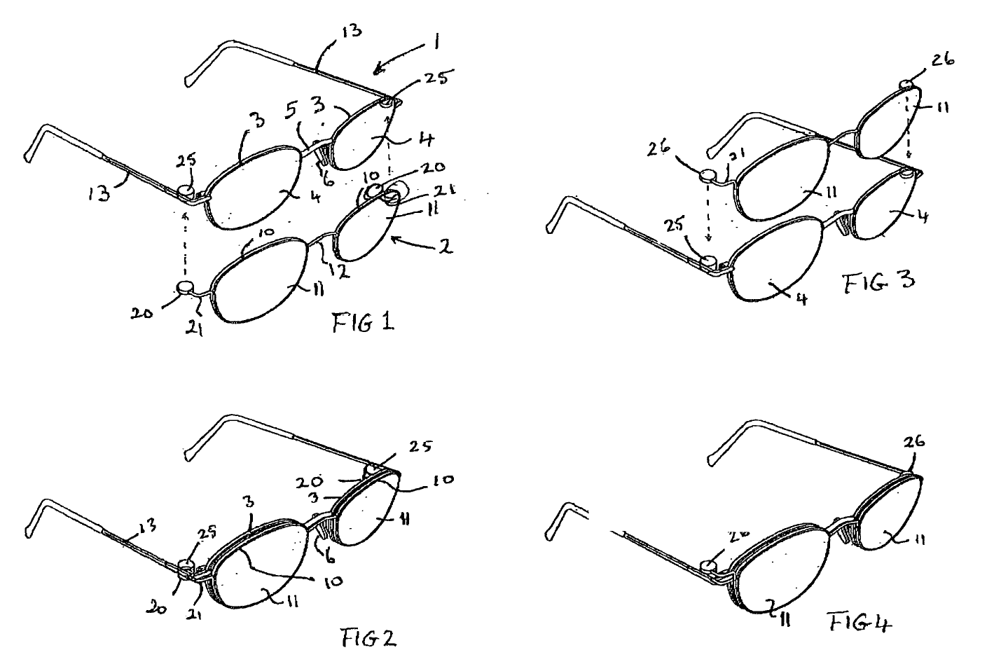

Referring now specifically to FIG. 1, second attachment means in the form of magnetic material are provided on each side of the auxiliary frame. These may take the form of small planar member, for example, the disks shown in FIG. 1, which are aligned in a substantially horizontal plan when the spectacle and auxiliary combination is in normal use on the head of a wearer. The disks 20 may be mounted on short arms 21 extending from the eyeglass holding frame 10. The magnetically attractable material may also be provided in the form of planar members such as disks 25 mounted on the spectacle frames, for example, on the arms 13 of the spectacle frames. In the embodiments shown in FIG. 1 planar members 20 and 25 are positioned such that if the members 20 are brought up beneath the members 25, once connected one with the other, the auxiliary spectacle frame 2 is held in the position shown in FIG. 2 with the frames 10 substantially overlying the frames 3 so as to gain the benefit of the auxiliary frames. The magnetic attraction between the planar members 20 and the plane or members 25 is selected so that the auxiliary spectacle frames will not readily fall from the primary spectacle but so that the connection can be overcome by simple manual pressure between the spectacle frames 1 and the auxiliary frames 2.

The construction of FIG. 3 is substantially similar. Planar members 26 are again in the form of disks mounted on arms 21. However the arms 21 are shaped so that the planar members 26 are able to be placed above the planar members 25. Again the eyeglass 11 substantially overlies the eyeglass 4.

Turning now to FIGS. 5 and 6. Again the construction is somewhat similar except that planar members 28, preferably of magnetic material, lie in a substantially vertical plane when the construction is normally placed on the head of a user. The spectacle frame 1 includes planar members 29, preferably of magnetically attractable material and as can be seen these also lie in a substantially vertical plane in use. In the embodiment shown in FIG. 5, the planar members 29 form part of the arms 13 and in particular a part of the arm 13 between the arm pivot point 30 and the eyeglass holding frame 3.

The short arms 21 on the auxiliary frame 2 are shaped so that the planar members 28 are positioned inside the planar members 29 as can be seen in FIG. 6.

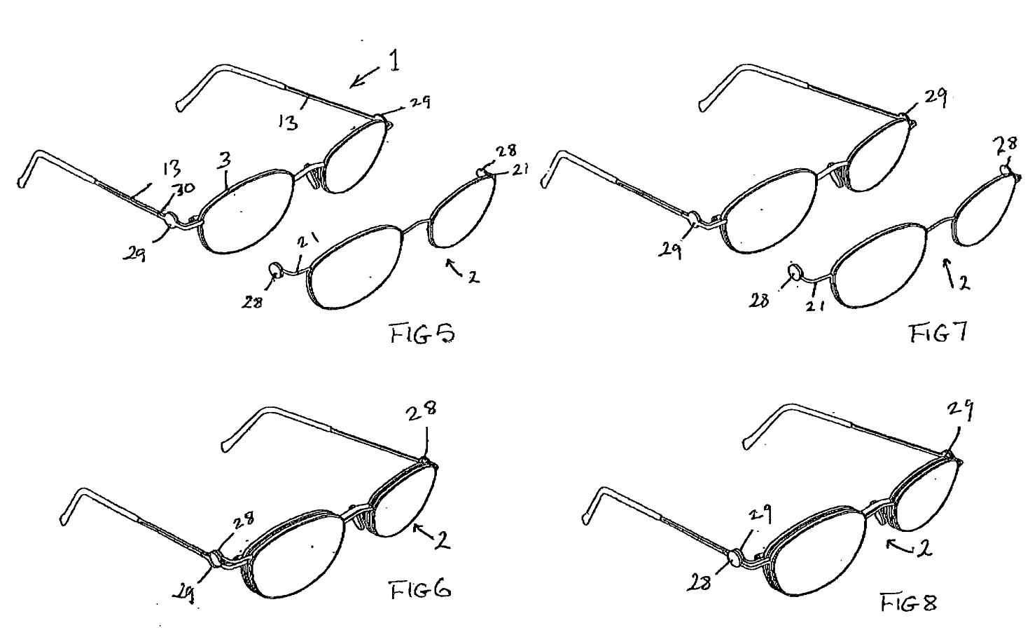

FIGS. 7 and 8 are substantially identical save that the short arms 21 are shaped so that the planar members 28 are positioned outside the planar members 29.

In the embodiments of FIGS. 3 to 8, again the magnetic attraction is such that the auxiliary frames 2 will be held in place during normal use but can be removed by simple manual pressure.

In use the spectacle frames and auxiliary frames are used in substantially the known fashion and as described above enabling the auxiliary frames to be placed on the spectacle frames and removed therefrom as desired.

Thus it can be seen that a combination of primary spectacle frames and detachable auxiliary spectacle frames is provided where the auxiliary frames utilise a magnetic “clip-on” means to hold them in position magnetic strips are attached to or embedded in the auxiliary frames but not in the main or primary spectacle frame which requires only to have magnetically attractable material. This has the advantage that the magnetic waves produced, when compared to conventional magnetic clip-on eyeglasses, is reduced by substantially 50%. The elimination of a pair of magnetic members on the primary frame also reduces the weight of the primary frame. As no magnetic members are required in the primary frame, the primary frame will be substantially as for typical ordinary eyeglasses in weight and also does not have the threat of damage to human brain nerves from harmful magnetic waves.

What is claimed is:

1. A combination comprising a spectacle frame and an auxiliary frame, the spectacle frame including spectacle eyeglass holding means, a pair of arms, and first attachment means. The auxiliary frame including auxiliary eyeglass holding means, and second attachment means, one of the first attachment means and second attachment means being formed of magnetic material and the other attachment means being formed of magnetically attractable material so that, in use, the auxiliary frame may be mounted on the spectacle frame by magnetic attraction between the first attachment means and second attachment means and with the auxiliary eyeglass holding means substantially overlying the spectacle eyeglass holding means.

2. A combination as claimed in claim 1, wherein the attachment means and second attachment means are provided in a pair of positions, one position being substantially at each side of the spectacle frame and auxiliary frame respectively.

3. A combination as claimed in claim 2, wherein the first attachment means comprises a pair of first planar members positioned one each side of the spectacle eyeglass holding means and the second attachment means comprises a pair of second planar members positioned one each side of the auxiliary eyeglass holding members.

4. A combination as claimed in claim 3, wherein the first and second planar members are substantially vertical when the spectacle frames are normally positioned on the head of a user.

5. A combination as claimed in claim 4, wherein the second planar members are outside the first planar members.

6. A combination as claimed in claim 4, wherein the second planar members are inside the first planar members.

7. A combination as claimed in claim 3, wherein the first and second planar members are substantially horizontal when the spectacle frames are normally positioned on the head of a user.

8. A combination as claimed in claim 7, wherein the second planar members are outside the first planar members.

9. A combination as claimed in claim 8, wherein the second planar members are inside the first planar members.

10. A combination as claimed in claim 7, wherein the first planar members form part of the structure of the arms of the spectacle frame.

11. A combination as claimed in claim 1, wherein the first attachment means are formed of magnetically attractable material and the second attachment means are formed of magnetic material.
